(19) United States
(12) Patent Application Publication
(10) Pub. No.: US 2013/0326464 A1
(43) Pub. Date: Dec. 5, 2013

(54) SADL Consumption Service

(71) Applicants: Marcel Hermanns, Heidelberg (DE); Oswald Gschnitzer, Heidelberg (DE); Faiz Mohamed Ibrahim, Walldorf (DE); Klaus Rehberger, Walldorf (DE)

(72) Inventors: Marcel Hermanns, Heidelberg (DE); Oswald Gschnitzer, Heidelberg (DE); Faiz Mohamed Ibrahim, Walldorf (DE); Klaus Rehberger, Walldorf (DE)

(73) Assignee: SAP AG, Walldorf (DE)

(21) Appl. No.: 13/488,068

(22) Filed: Jun. 4, 2012

(51) Int. Cl. G06F 9/44

(52) U.S. Cl. 717/100

(57) ABSTRACT

Embodiments relate to computing, and in particular, to methods, apparatuses and systems for operating on a database. Certain embodiments implement a consumption services reference by an SADL design-time tool that allows users to create SADL use modes based on existing Business Objects (BOs), business object entities and associations. The consumption service can provide a design-time tool or user with indications of a particular BO entity's availability based on a particular consumption scenario within a given SADL mode. Indications of availability can be built into or referenced by the design-time tool to give users design-time feedback as to why a certain BO entity is not available. The indications of availability can be provided separately from a compiler or compiler functionality. The indications of availability can be also be reused by the compiler, thus reducing redundant checks and operations and decoupling the compiler and any design-time tool from the check logic.

### CROSS REFERENCE TO RELATED APPLICATIONS

The present application is related to U.S. application Ser. No. 12/972,157 for “SADL Query View—A Model-Driven Approach to Speed-Up Read-only Use Cases”, filed on Dec. 17, 2010, and U.S. application Ser. No. 12/648,216, for “Service Adaptation Definition Language,” filed on Dec. 28, 2009, both of which are incorporated herein by reference in their entirety for all purposes.

### BACKGROUND

The present disclosure relates to computing, and in particular, to systems and methods for a consumption service for development/design-time tools that runs pre-compile-time and pre-run-time checks to determine which business objects are available, or consumable, for various use cases or scenarios. Such consumption services permit the developer to interact with databases and business objects to produce customized, or non-normalized, views, reports and results, quickly and efficiently by providing listings of available business objects or other indications as to whether the underlying data or business objects and their associations are available for consumption in the design-time environment. Such embodiments save time, development resources, and computing resources, by reducing or eliminating the need to compile design-time output to determine if a particular individual business object is available to be consumed in a particular use case.

Unless otherwise indicated herein, the approaches described in this section are not prior art to the claims in this application and are not admitted to be prior art by inclusion in this section.

Databases and business objects are highly useful tools allowing users to manage complex relationships between large amounts of different types of data. FIG. 1 shows a highly simplified view of a system 100 comprising a human user 102 who is in communication with a database 104 through an intervening user interface (UI) 106. When a large volume of data is requested to be read, analyzed, and returned in a denormalized view from the database 104, in general the UI 106 will formulate a use scenario, such as a query, search, or free search 108 having features 109, to the database. The database 104 can include a large number of instantiated business objects, entities, that include attributes and associations with other business objects.

FIG. 2 shows an example of a screen shot 200 of a use case with a user interface designed for an end user to pose a query or run a search. In the design-time environment, a designer would have to ensure that the instances of the business objects and/or the business object entities would be consumable for this particular query use case. To check that the business objects entities were available for the UI use case or the underlying query, the designer may have needed to compile the UI and/or the query several times to determine that the account name entity instantiated from a particular business object was available for the pull-down type or natural language search.

Accordingly, conventional design-time tools are deficient in their ability to predetermine which business objects are consumable to the various consumption scenarios in a given use mode, such as the user interface discussed above. Reasons for this deficiency include the large number of intervening layers actually present between the use mode and the underlying data of the database, complexity of associations between business objects, administrative and policy based restrictions, and other variables. Conventional design-time tools do not have the resources or functionality to determine which business objects are consumable for the various consumption scenarios in a given use mode.

Design-time efforts are further complicated by the fact that SADL modes that support different approaches can include a variety of different consumption scenarios, such as queries, searches, and free or natural language searches. The task of creating an SADL in a specific mode in a design-time tool is further complicated by the fact that designer using a design-time tool working with artifacts that are mapped to an SADL artifact in a specific mode, such as a UI model that is mapped to an SADL virtual business object or a message assembly in web-services using SADL to fill in nested tables, needs to know which business entities or types are available for the selected SADL mode and use scenarios specified to avoid compile-time or run-time errors. To avoid such errors, conventional SADL design-time tool to defer to an SADL compiler to check whether particular business object entities and types are available for a particular SADL mode. This would require sending interim versions of the SADL artifact or use scenario to the compiler to determine which business object entities used in the SADL mode would cause a compile-time or run-time errors. Basically, the design-time tool would have to learn all of the restrictions on the ability of a business object to be consumed in a particular use scenario. Clearly, sending such interim designs to the SADL compiler to check the availability of a business object entity not only wastes time and computing resources during development, but can also cause redundant checks to be performed and potential inconsistencies in the availability results amongst various design-time tools and SADL compilers with differing restrictions.

The present disclosure addresses these and other issues with systems and methods for a consumption service that perform pre-checks on the availability of a given business object to be consumed in a given use scenario of a given an SADL in a given mode that allows a development/design-time tool to decrease design-time and to avoid run-time and compile-time errors.

### SUMMARY

Embodiments of the disclosure relate to computing, and in particular, to systems and methods for determining the availability of a business object or business object entity for use in a particular SADL mode based on consumption scenarios and other factors.

Certain embodiments are directed toward methods, computer readable medium and computer systems for providing a design-time tool that uses a number of business objects (BO) or business object entities and references a consumption service to determine which of the business objects or business object entities are consumable by various use scenarios from within the design-time tool, and providing a user interface with indications of which business object entities are consumable for the various use scenarios within the a particular use mode being designed in the design-time tool.

Other embodiments further include performing, using the consumption service, a check routine to determine which of business objects or business object entities are consumable within the use mode or use scenarios.

In certain embodiments the check routine includes multiple checks and check logic.

In certain embodiments the checks and check logic are based on a multiple factors comprising an SADL mode and a consumption scenario.

Certain embodiments further include providing a user interface having a plurality of indications of availability status for the number of business object entities

In certain embodiments the indications of availability status include error codes or error messages.

In certain embodiments the design-tool and performing the check routine are separate from a compiler or any compiler functionality.

### BRIEF DESCRIPTION OF THE DRAWINGS

FIG. 1 shows a generic view of interaction of a user with a database through a user interface according to the present disclosure.

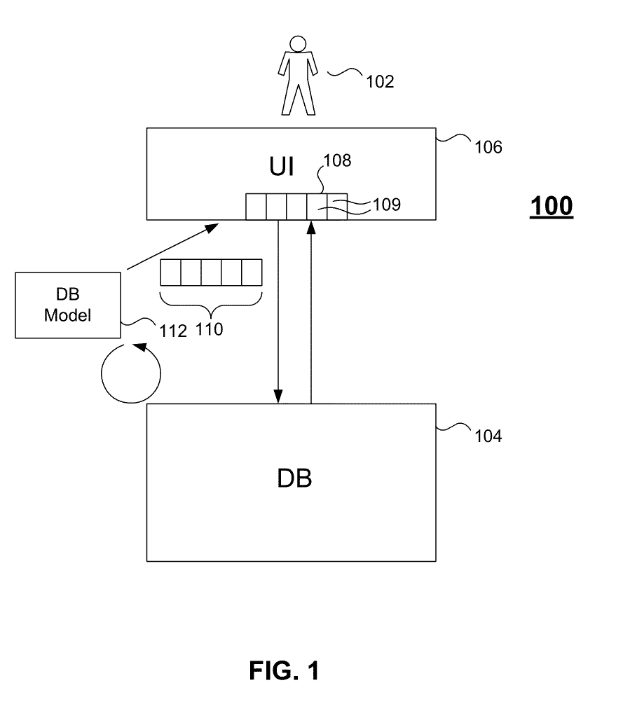

FIG. 2 shows a screen shot of a window of a user interface according to the present disclosure.

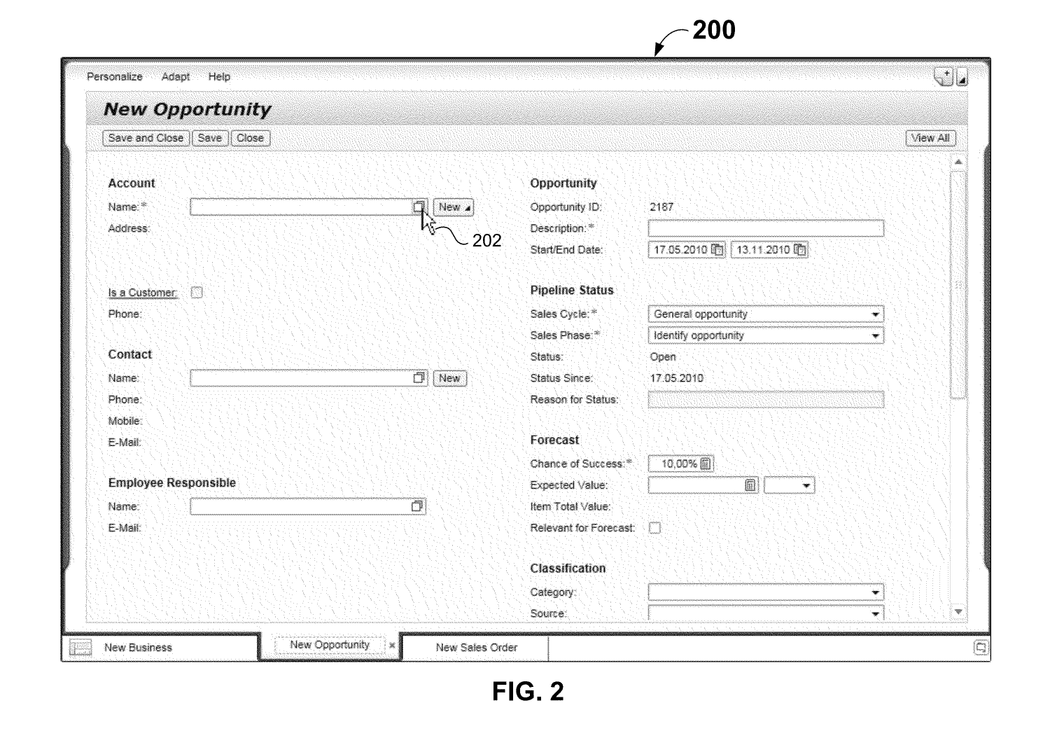

FIG. 3 shows a screen shot of a window of a user interface according to the present disclosure.

FIG. 4 shows a simplified flow of an embodiment of a method according to the present disclosure.

FIG. 5 shows in simplified schematic a system that includes consumptions services according to the present disclosure.

FIG. 6 illustrates an example of a computer system.

### DETAILED DESCRIPTION

Described herein are techniques for a consumption service that can evaluate the availability of a business object or business object entity to be consumed in a use-case or consumption scenario of a particular use mode and give a user or a design-time tool an indication of availability of the business object or business object entity while creating a use mode without reference to a compiler. Such techniques are useful in the creation of service adaption description language (SADL) artifacts.

Embodiments of the present disclosure relate to a consumption service or consumption checking service that allows a design-time tool which permits designer to create use modes that use, operates on, or otherwise consume business objects and their associations using only business object entities that are available for consumption without referring to an SADL compiler. The design time is decoupled by from the actual check routines. Changes in the check routines can be performed centrally without altering the design time methods or tools. Particular embodiments are based upon a modeling of business level entities using the Business Objects (BO)-related domain specific language SADL, as described in the U.S. Nonprovisional patent application Ser. No. 12/648,216 filed Dec. 28, 2009 and incorporated by reference in its entirety herein for all purposes.

As used herein, business objects can include data models and business logic consisting of several entities, such as nodes, associations, and node elements. SADL is a view building multi-purpose language that can traverse business objects to define a new external SADL structures. SADL modes are supported use cases by SADL, one such mode can cover multiple consumption scenarios. A particular SADL artifact is an instance of an SADL mode. For example, an SADL artifact can represent on user interface.

The apparatuses, methods, and techniques described below may be implemented as a computer program (software) executing on one or more computers. The computer program may further be stored on a computer readable medium. The computer readable medium may include instructions for performing the processes described below.

In the following description, for purposes of explanation, examples and specific details are set forth in order to provide a thorough understanding of various embodiments of the present disclosure. It will be evident, however, to one skilled in the art that the present invention as defined by the claims may include some or all of the features in these examples alone or in combination with other features described below, and may further include modifications and equivalents of the features and concepts described herein.

Various embodiments of the present disclosure provide for an SADL consumption service that provides information about the availability of BO entities for different SADL consumption scenarios in order to separate the check logic from any SADL related development/design-time tool or SADL compiler. The availability of a BO entity depends on the entity type, its properties, the particular consumption scenario, as well as other possible factors, restrictions, and rules applicable to the business objects or business object entities.

Consumption scenarios can be a delegation to the business object run-time for transactional scenarios or can be based on in-memory technology with advanced search and query capabilities. SADL modes can also mix multiple consumption scenarios. The consumption information defines the availability of a business object entity in a consumption scenario for a particular SADL mode. A BO entity can be available for use in a particular scenario or it can be designated as unavailable for at least one reason. If the BO entity is not available, then the consumption information can include details as to why the BO entity is not available. Accordingly, business objects can include a data model along with associated business logic pertaining to that data model. As such a discussion of business objects can be divided into discussion of the data model structure and business logic behavior.

With respect to the structure, the data model is a graph containing several nodes including at least one special node, such at the root node. Starting from the root node, a tree of nodes branches out over several sub-nodes, each sub-node is related to the parent node via a number of compositions. Besides the compositions other associations can be defined between the various nodes. Such associations can even link different business objects.

Each node of a business object can represent a database (DB) table. The columns of the DB table are the node elements of the node. Node elements can be structured and are typed with the CCTS. Associations can include directed joins starting from a source node and leading to a target node. The syntax of an association can be based on association metadata defining various conditional statements. The left hand side of a conditional statement can be a path to an attribute starting from the target node, the right hand side of the conditional statement can depend of the type of binding in the association metadata. For example:
Attribute Binding: Foreign Key relationships (also for Compositions)
   e.g. NODE_ID=PARENT_NODE_ID
   e.g. UUID_AK=UUID_FK
Constant Binding: Restrictions of the target node by constants value
   e.g. LANGUAGE_CODE=‘DE’
System-Variable Binding: Optional restrictions of the target node by system variables
   e.g. LANGUAGE_CODE=SY-LANGU
Filter Binding: Association Filter Parameter can optionally be filled when the association is consumed/traversed
   e.g. LANG_CODE=$$FILTER$$

Each BO entity can be associated with several properties. For example, a node element can be designated as read-only, disabled or transient (e.g. calculated) by one or more properties or property indicators.

In addition to the data model being defined by the nodes, associations (including the compositions) and the node elements, a business object can include business logic that is related to this data. The behavior of the business object can be further distinguished as internal and external behavior. For example, external behavior can include actions that can be triggered by a consumer or developer. The internal behavior can be triggered automatically by the business object itself.

Externally triggered behavior can include actions that are explicitly triggered by a consumer or developer. For example, an action to change the status of one or more business object instances, such as accepting or declining a sales order instance, are externally triggered actions. According to some embodiments, actions are defined by the application of the action to a business object node. Similarly, queries are another functionality that can be made available to a consumer or developer to allow the consumer or developer to select from the business object node by searching for special values in node elements that are exposed or designated as query input parameters.

Internally trigger behaviors can include expressions and determinations of node elements. Some of the node elements can be determined based on values of other node elements in the same or different business object nodes. Additionally, the internally triggered behaviors can be based on run-time values and variable, such as the current date to determine the age of a person. In various embodiments, a node element can be defined based on an expression where operators are constant values, system variables or other node elements. Simple calculation rules can be defined by using an expression language interpretable in different layers (e.g. UI, Backend and database). In related embodiments, complex calculations might be not definable by an expression. In such embodiments, a determination can be implemented manually in a well-defined code exit.

In various embodiments, a business object defines a normalized data model. Since users are typically interested in a denormalized or custom views of this data, the service adaption description language (SADL) allows the definition of custom views on top of business objects exposed via a SADL mode specific external structure available to users. An external SADL structure is defined by traversing through the underlying business objects, their nodes and associations. Entities of the business object can be mapped and exposed to the external SADL structure (e.g. node elements) or can be used to define new entities for the external SADL structure (e.g. calculations based on several business object elements).

The relationship between business objects and SADL is analogous to the relationship of database (DB) tables and DB Views. Entities of the underlying business objects (similar to DB tables) are projected and mixed to a new external SADL structure (DB View). In contrast to DB views, SADL supports columns/node elements and projections, as well as projections of actions, queries, and run-time delegations to the business logic.

According to various embodiments, SADL is a multi-purpose language that can support different concepts for different use cases. For each SADL mode, several aspects of the modes can vary from mode to mode. For example, the type of the external SADL structure, the supported set of syntax elements, the types of business object entities that can be consumed, and the set of restrictions to be fulfilled by each business object entity, can be different in to be consumable in a particular SADL Mode.

Examples for SADL Modes by Use Cases

In an exemplary use case, the external SADL structure can be a nested table represented in a programming language. The nested table is explicitly defined by the structure of the SADL syntax. Each table of the external SADL structure is bound to a business object node. In such bindings, the columns of the table are bound to node elements or calculated values. In such use cases, no actions or queries can be consumed in SADL.

In another exemplary use case, the definition of new queries with SADL can result in an executable entity that returns a flat structure. Within the new query business object, node elements can be selected by traversing through the business objects. Therefore the business object data model is mapped to the DB representation with DB tables, columns and joins between the tables. Actions and queries of the business object are not consumable. Specifically, within the definition of a query with SADL no actions and queries of the underlying business objects can be mapped. In cases in which the generated run-time artifact (e.g. FSI Query) allows only the binding of flat node elements, the mode is restricted to flat node elements. Each node element must be selectable from the database (e.g. in case of TREX replicable). Additionally the syntax of each association can be fully modeled via bindings in the association metadata, otherwise a mapping to DB joins would not be possible.

In yet another exemplary use case, SADL can be used to represent the data model of UI. In such embodiments, SADL can also be used to define a new virtual business object used in backend processes to serve UI requests. Each BO entity type, such as actions, queries, and node elements, can be mapped to an external SADL structure. Additionally, new queries can be defined.

The definition of a new query within the virtual BO is based on bindings to the underlying business object node elements. The output is implicitly defined by the node, the query input parameters are bound to one or more node elements. A special input parameter represents the search-text for a free text search on multiple node elements, such as a search in multiple DB table columns

Check and Check Routines

According to various embodiments, a consumption service can perform various checks and check routines based on multiple factors to determine whether a particular BO entity can be consumed in various consumption scenarios or SADL modes. The following list of exclusions and inclusions includes exemplary root reasons why, depending on the consumption scenario, a business object entity may or may not be available or allowed in a given SADL mode. The extent and complexity of the following non-exhaustive list illustrates the issues and problems that can hamper the design process using conventional design-time tools. Each exclusion and inclusion in the list would normally need to be checked during compile-time or learned by the design-time tool, but embodiments of the present invention that include the consumption services can perform the multifactor checks and check routines, this can reference or include some or all of the following list, during design-time. Accordingly, checks and/or exclusions and inclusions can be added, edited, or deleted from the check routines without changing the design-time tool to determine which business objects are consumable by which use scenarios at compile-time or run-time.

Exemplary Exclusion List:
Node ‘&BO_NODE&’ is not replicable
Filter Parameter ‘&ASSOC_FILTER_PARAM&’ is not bound
Filter Parameter ‘&ASSOC_FILTER_PARAM&’ bound to not replicable bo node element ‘&NODE_ELEMENT&’
Attribute ‘&NODE_ELEMENT&’ is not replicable
Attribute ‘&NODE_ELEMENT&’ is not flat
Source or target attribute ‘&NODE_ELEMENT&’ of association ‘&ASSOCIATION&’ not replicable
Attribute ‘&NODE_ELEMENT&’ is neither shallow nor flat
Association ‘&ASSOCIATION&’ is of type cross-DU, but cross-DU usage is not enabled
Attribute ‘&NODE_ELEMENT&’ with forbidden data type ‘&DATA_TYPE&’
Association ‘&ASSOCIATION&’ is final disabled
Attribute ‘&NODE_ELEMENT&’ is final disabled
Attribute ‘&NODE_ELEMENT&’ with data type ‘&DATA_TYPE&’ does not have a valid implementation code
Node ‘&BO_NODE&’ of BO ‘&BO&’ is final disabled
Attribute ‘&NODE_ELEMENT&’ with data type ‘&DATA_TYPE&’ does not have a valid representation term
Filter Parameter ‘&ASSOC_FILTER_PARAM&’ of association ‘&ASSOCIATION&’ is final disabled
Target node ‘&TARGET_NODE&’ of association ‘&ASSOCIATION&’ is final disabled
Association ‘&ASSOCIATION&’ of BO ‘&BO&’ node ‘&BO_NODE&’ is not modeled correctly
BO ‘&BO&’ is not replicable
Target node ‘&TARGET_NODE&’ of association ‘&ASSOCIATION&’ is not replicable
BO ‘&BO&’ is not a core BO
Deep attribute ‘&NODE_ELEMENT&’ with non-replicable enabled elements

Exemplary Inclusion List
MaxBO Projections or business objects with a common structure, so called projections of a template, where the instances are in a shared DB table, are allowed to be used in query use cases, even if there is no persistency, but a shared one in the template.
Transformation Objects might be usable in future if they are used for navigation purpose only.
Calculated fields defined might be executable in the DB in case the expression is executable there.

In various embodiments of the present disclosure, a consumption services module or server can be accessed by any one of the layers of the design-time tools of the described embodiments. The consumption service can work with artifacts that are mapped to a SADL artifact in a specific mode, such as a UI model that is mapped to an SADL virtual BO or a message assembly in web-services that uses SADL to fill nested tables. The consumption service can ensure that only those BO entity types are selectable in the development/design-time tool UI that are allowed to be used in the selected SADL mode. If the BO entity types are not allowed or unavailable for the selected SADL mode, then they can be grayed out or absent from the UI.

Various embodiments of the consumption service can separate concerns between the SADL development/design-time tool and the SADL compiler. For example, checks and check routines discussed above can be handled by a set of rules, such as the exclusions and inclusions listed above, that are verified by the consumption service. In related embodiments, the SADL consumption services module or server can provide information about the availability of the business object entities for different scenarios based on a given SADL mode. In case a BO entity is not available for a given consumptions scenario, the consumption service module or server can provide detailed information why the entity is not available. For example, if an association is not fully modeled, then it cannot be used in a SADL mode support the query scenario. The information is provided by a parameterized message class objects (OTR message) that can be displayed language-specific to an application developer. Consumption service module or server can enable generic design-time tools to display only those business object entities that can be consumed in the particular SADL mode. In such embodiments, the consumption service module separates the check logic from the development/design-time tool. Additionally, check routines can include the checks and the check logic.

For purposes of illustration, consumption scenarios are now discussed. SADL is a multi-purpose language that can support several run-times. Accordingly, the business object entities managed by the consumption service module can be subject to different restrictions. If SADL query is used in order to generate DB-like views or to provide a high efficiency query run-times with in-memory access, then several of restrictions discussed above can apply. In query usages, node elements can also be bound in the input parameter or even the input parameter for the free text search of the query.

However consumption scenarios do not necessarily have a one-to-one relationship to the different SADL modes, since multiple consumption scenarios can occur within one SADL mode. The restrictions of a consumption scenario can also differ for different modes. For example, a mapping of structured node elements might be allowed in a virtual BO query, but not in generating an FSI query for a particular business object node. The following table shows examples of various consumption scenarios and the business objects for which they are applicable or available.

| | General | | Input | Basic |
|---|---|---|---|---|
| Business Object | (BO run-time | SADL | Parameter | Search of |
| Entity Type | and BSA++) | Query | of a query | a query |
| Business Object | X | X | | |
| Node | X | X | | |
| Association | X | X | | |
| Filter | X | X | | |
| Node Element | X | X | X | X |

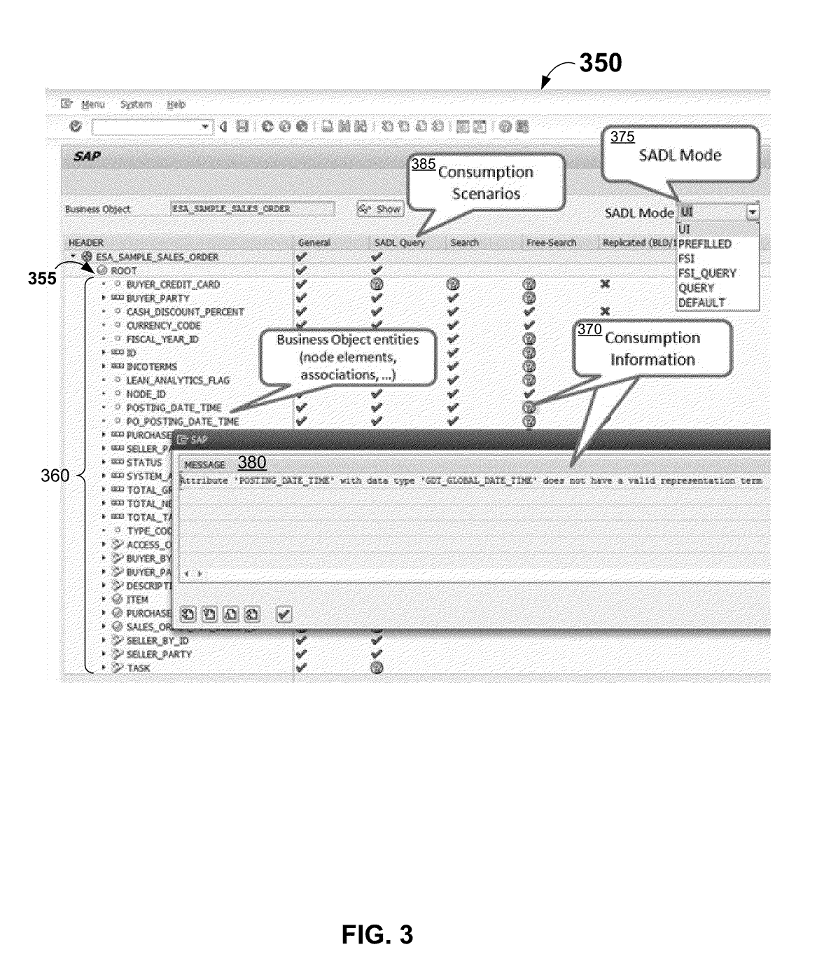

FIG. 3 shows a screenshot that graphically show the output of the consumption service module that can be included in or references by a design-time tool or referenced by a designer at design-time according various embodiments. FIG. 3 shows a screen shot of UI 350 with a representation of BO ‘ESA_SAMPLE_SALES_ORDER’ starting from the root node 355 with its associations and node elements 360 and the consumption information 370 for the SADL mode virtual business object or UI 375. The error message 380 can be the output of the consumption service having performed one of the checks or check routines discussed in reference to the exclusion list above. Each BO or BO entity 360 is shown and includes an indication as to whether it is consumable to a referenced consumption scenario 385, i.e. general, SADL Query, Search, Free-Search, etc., in the particular SADL mode 375. The indication as to whether the BO or BO entity is consumable by the referenced consumption scenario 385 can include the consumption information 370 that can include an icon or text shown in the error message 380.

When a user or developer selects or attempts to drag and drop, or otherwise select, a particular BO entity that might not be allowed for a specific mode, the UI 350 can indicate why that BO entity cannot be used. In some embodiments, the indication that a BO entity cannot be used can be an error message like error message 380. In other embodiments, the indication that a particular BO entity is not allowed can include a marker or a grayed out name of the BO entity. Furthermore, the indication can be static or dynamic with respect to a pointer in the UI 380 and vary based on the one or more consumption scenarios 385.

Various embodiments of the present disclosure also include an SADL consumption service application public interface (API). The SADL consumption service API wraps the business object traversal API provided by ESF2, which contains calls such as:
get_root_node ( ), get_nodes ( )
get_node_elements ( ) for a specific business object node
get_associations ( ) for a specific node
. . .

In addition to the metadata provided by the ESF2 API the consumption service adds the consumption information 370 for each entity for each scenario with flags for whether the entity is allowed and a list of messages to return when the entity is not allowed for the scenario. The SADL consumption service API also provides information for a given BO and a given SADL.

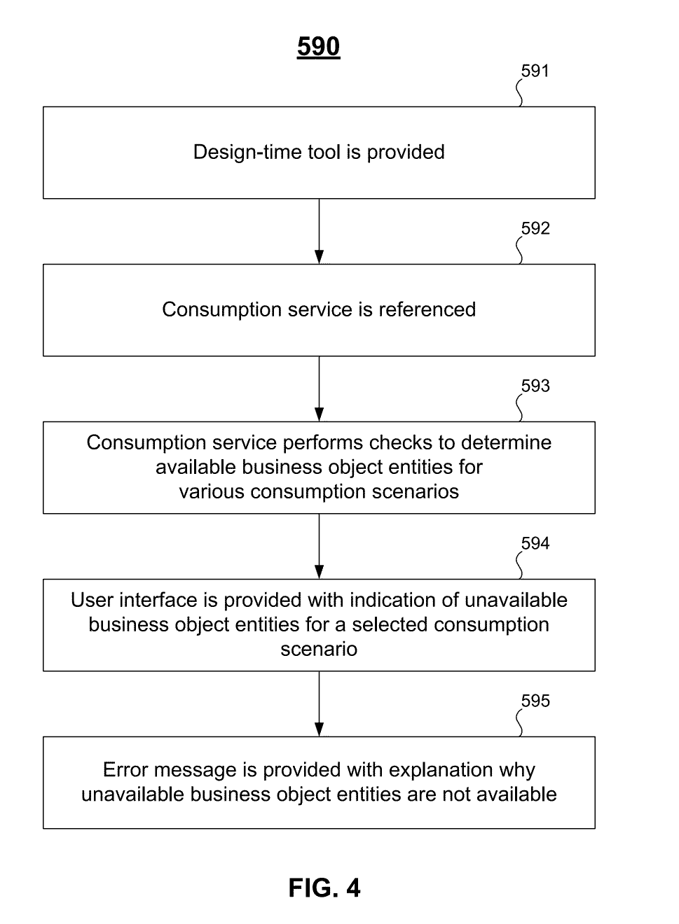

FIG. 4 shows a flowchart 490 of a method according to the present disclosure. In action 491, a design-time tool can be provided to a user. The design-time tool can be a combination of user interfaces and underlying systems and data structures described herein. In some embodiments, the design-time tool can include a call to a consumption service in one or more layers. The higher the layer in which the consumption service is called, the more efficient the use of the consumption service can be.

In some embodiments, the consumption service can be called by or included in a consumption service module embedded in or included the design-time tool. In other embodiments, the consumption service is hosted on a server accessible by the design-time tool. The server on which the consumption service is hosted can be an actual or virtual server that can include multiple instances of the consumption service servicing or accessible to multiple users using multiple design-time tools.

In any of such embodiments, the consumption service can be referenced, either manually by the designer or automatically by the internal calls to the consumption service from within the design-time tool, in action 492.

In action 493, the consumption service can perform various checks to determine which BO entities can be used in various consumption scenarios. In some embodiments, the checks that determine availability of a BO entity can be based on multiple factors. Such factors can include, but are not limited to, the consumption scenario, the SADL mode or usage case, qualities and status of the BO entities, and rules and restrictions imposed by the owner or creator of the business object. The qualities and status of the BO entities can include whether the BO entities are stored, calculated, in-memory, in-process, or being updated or otherwise offline or unavailable for retrieval or calculation. The rules and restrictions applied can include security and privacy settings that can be applied to restrict the use of the BO entities to developers or users that have sufficient security or privacy credentials.

Once the consumption service has determined which BO entities are and are not available, in action 494, a user interface can be provided with indications of available and unavailable business object entities for a selected consumption scenario or SADL mode according to various embodiments described herein. In related embodiments, the indication that a particular BO entity is unavailable can include providing an error message with an explanation why the unavailable business entities are not available in action 495. The message can include an error code and/or a natural language explanation regarding the availability status of a particular business object entity. The availability status of the particular business entity can include indications of “available” or “unavailable.” Each of such indications of availability status can include graphical indications, such as textual or pictorial indications. For example, the pictorial indications can include universal signs or self-explanatory icons.

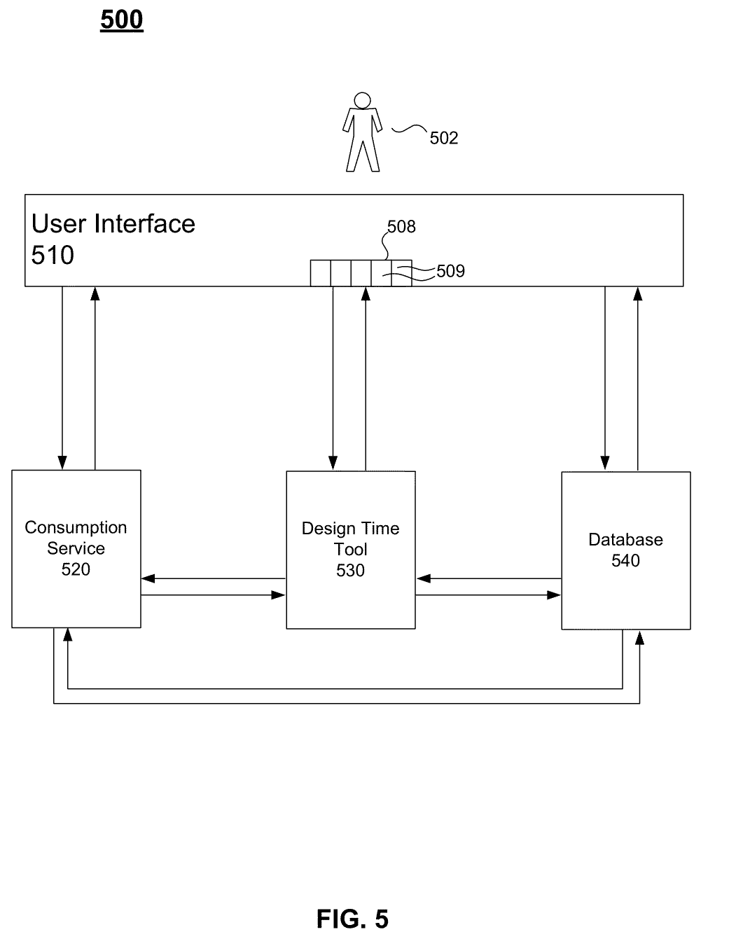

FIG. 5 shows a block diagram of a system according to various embodiments of the present invention. In such embodiments, a user 502, such as a SADL mode user or designer can interact with a user interface 510. The user interface 510 can include any type of computer-user interface suitable for designing and/or laying out SADL mode or use cases. For example, user interface 510 can include a graphical user interface (GUI), a text or command line interface, or combination of the two displayed on one or more computer displays. In other embodiments, the user interface 510 can include a voice control or user-motion control element or module, such that a user can interface with the user interface 502 with or without looking at a computer display.

The user interface 510 can include a number of fields 508 for specifying various data and information 509 from other modules and computer systems, such as consumption service 520, design-time tool 530, and database 540. Each of consumption service 520, design-time tool 530, and database 540 can be implemented as a software module instantiated on a single computer or computers server, or can be run on multiple networked computers or server computers. The user interface 510 can be run on a networked client computer or other computing device, such as a portable consumer device or smart phone. Each of the user interface 510, consumption service 520, design-time tool 530, and database 540 can communicate with one another over various secured and unsecured network or communication protocols via wired and wireless bidirectional connections, as shown.

A user 502 can use user interface 510 to access design-time tool 530 to design, compile, run, execute, and test various SADL modes, consumption scenarios, and other variables and specifications for interacting with a data that can include BOs and other information stored in data bases. As shown, the both the user interface 510 and the design-time tool 530 can include connections for reading and writing information to database 540. For example, a user 502 can use user interface 510 to execute or invoke an instance of the design-time tool 530. The design-time tool 530 can then have a graphical or text-based interface displayed to the user 502. From within such s design-time tool interface, the user 502 can enter, select, or otherwise specify various fields 508 with specific values, ranges, or templates to design a particular SADL artifact in a given mode or use case that operates on or consumes data or BOs stored in database 540. As such, design-time tool 530 can be used to create denormalized views, reports, analysis and other use cases of the BOs and data stored in the database 540.

However, not all BOs or BO entities stored in the database 540 will be available for or consumable by each use case the design-time tool 530 can construct. To determine whether a particular BO or BO entity is consumable by the use case designed using the design-time tool 530, or the user 502 via user interface 510 can reference consumption service 520 to determine if a particular BO or BO entity can be used in a particular can be used in a particular use case as specified by user 502 in fields 508 and entries 509.

The consumption 520 can perform pre-check, real-time checks, and other check routines on the BOs and BO entities to determine whether one or more of the BOs or BO entities can be consumed in the use case developed, designed, or otherwise specified. Such checks and check routines can be performed before and during the time in which the design-time tool 530 is being used and before the SADL artifact or use case is compiled by a compiler (not shown) or in another compile time operation. To perform the checks and check routines, the consumption service can reference rules, exclusions, inclusions, limitations, and restrictions associated with user 502, user interface 510 or the client computer on which it is displayed/running, the design-time tool 530, database 540, and any data and BOs stored in the database 520 via the connections shown in FIG. 5.

The results of such checks can be sent to the user interface 510 or the design-time tool 530 to provide a user/designer of a SADL artifact with an indication which BOs or BO entities are available to be consumed in a particular consumption scenario in the SADL mode. In some embodiments, the indication can include excluding BOs and BO entities from being displayed as possible choices in the user interface 510 or design-time tool 530. In other embodiments, the indication can include a visual indication that a particular BO or BO entity is not available for a chosen SADL mode, such as listing the BO or BO entity as grayed out, crossed out, or otherwise not selectable via the user interface 510. In yet other embodiments, a listing of BO and BO entities can be displayed in a table or chart form. Rows of BO or BO entities can be associated with columns associated with a particular consumption scenario such that each row is associated with multiple columns of consumption scenarios with indications as to whether the BO or BO entity in each row is consumable for a the consumption scenario. In some embodiments, the consumption service can also provide error messages or error codes that include or are associated with explanations or results of the checks and checks routines as to why a particular BO or BO entity is not available for use in a particular consumption scenario.

According to various embodiments of the present invention, the consumption service and other elements can be implemented in a computer system. The computer system may comprise a software server. A number of software servers together may form a cluster, or logical network of computer systems programmed with software programs that communicate with each other and work together to process requests between the user interface 510, the consumption service 520, design-time tool 530, and database 540.

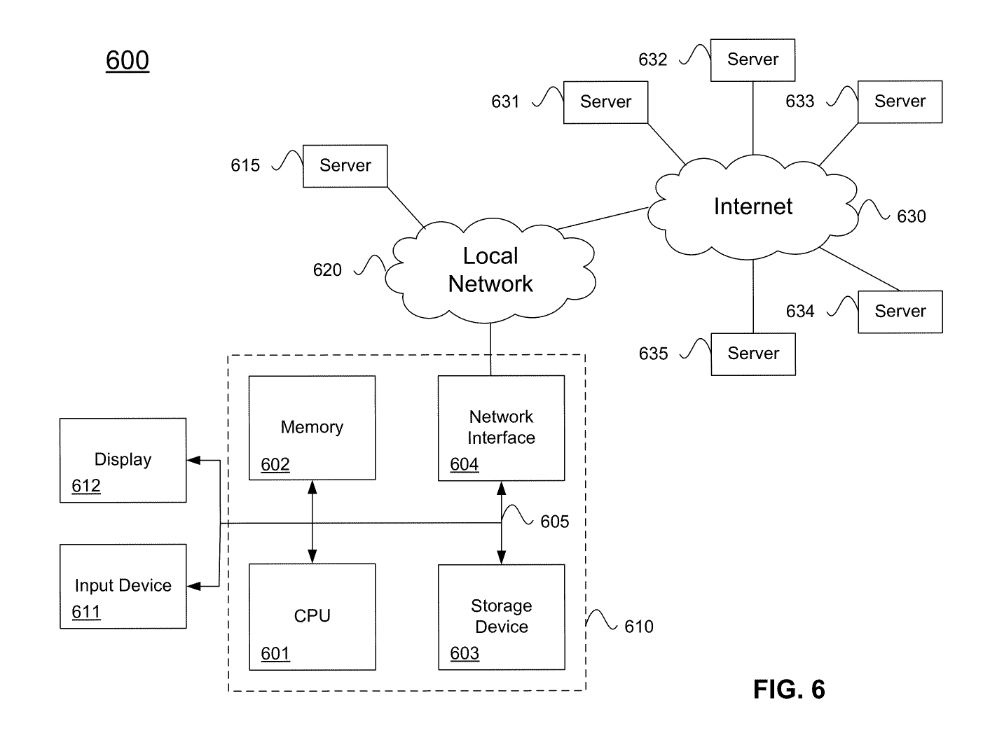

An example computer system 610 that can use used to implement various embodiments of the present invention is illustrated in FIG. 6. Computer system 610 includes a bus 605 or other communication mechanism for communicating information, and a processor 601 coupled with bus 605 for processing information.

Computer system 610 also includes a memory 602 coupled to bus 605 for storing information and instructions to be executed by processor 601, including information and instructions for performing the techniques described above, for example. This memory may also be used for storing variables or other intermediate information during execution of instructions to be executed by processor 601. Possible implementations of this memory may be, but are not limited to, random access memory (RAM), read only memory (ROM), or both.

A storage device 603 is also provided for storing information and instructions. Common forms of storage devices include, for example, a hard drive, a magnetic disk, an optical disk, a CD-ROM, a DVD, a flash memory, a USB memory card, or any other medium from which a computer can read.

Storage device 603 may include source code, binary code, or software files for performing the techniques above, for example. Storage device and memory are both examples of computer readable media.

Computer system 610 may be coupled via bus 605 to a display 612, such as a cathode ray tube (CRT) or liquid crystal display (LCD), for displaying information to a computer user. An input device 611 such as an in-vehicle touch screen, is coupled to bus 605 for communicating information and command selections from the user to processor 601. The combination of these components allows the user to communicate with the system. In some systems, bus 605 may be divided into multiple specialized buses.

Computer system 610 also includes a network interface 604 coupled with bus 605. Network interface 604 may provide two-way data communication between computer system 610 and the local network 620. The network interface 604 may be for Broadband Wireless Access (BWA) technologies. In any such implementation, network interface 604 sends and receives electrical, electromagnetic, or optical signals that carry digital data streams representing various types of information.

Computer system 610 can send and receive information, including messages or other interface actions, through the network interface 604 across a local network 620, an Intranet, or the Internet 630. For a local network, computer system 610 may communicate with a plurality of other computer machines, such as server 615. Accordingly, computer system 610 and server computer systems represented by server 615 may form a cloud computing network, which may be programmed with processes described herein.

In an example involving the Internet, software components or services may reside on multiple different computer systems 610 or servers 631-635 across the network. The processes described above may be implemented on one or more servers, for example. A server 631 may transmit actions or messages from one component, through Internet 630, local network 620, and network interface 604 to a component on computer system 610. The software components and processes described above may be implemented on any computer system and send and/or receive information across a network, for example.

The above description illustrates various embodiments of the present disclosure along with examples of how aspects of the present disclosure may be implemented. The above examples and embodiments should not be deemed to be the only embodiments, and are presented to illustrate the flexibility and advantages of the present disclosure as defined by the following claims. Based on the above disclosure and the following claims, other arrangements, embodiments, implementations and equivalents will be evident to those skilled in the art and may be employed without departing from the spirit and scope of the disclosure as defined by the claims.

What is claimed is:

1. A computer-implemented method comprising:
providing a design-time tool that operates on a business object comprising a plurality of business object entities;
referencing a consumption service to determine which of the plurality of business object entities are available to the design-time tool;
providing a user interface with indications of which of the plurality of business object entities are available to the design-time tool.

2. The computer-implemented method of claim 1 further comprising performing, using the consumption service, a check routine to determine which of the plurality of business object entities are available to the design-time tool.

3. The computer-implemented method of claim 2, wherein the check routine comprises a plurality of checks and check logic.

4. The computer-implemented method of claim 3, wherein the checks and check logic are based on a plurality of factors comprising an SADL mode and consumption scenario.

5. The computer-implemented method of claim 2 further comprising providing a user interface comprising a plurality of indications of availability status for the plurality of business object entities.

6. The computer-implemented method of claim 5 wherein the indications of availability status comprise error codes or error messages.

7. The computer-implemented method of claim 2, wherein the design-tool and performing the check routine are separate from a compiler.

8. A non-transitory computer readable storage medium embodying a computer program for performing a method, said method comprising:
providing a design-time tool that operates on a business object comprising a plurality of business object entities;
referencing a consumption service to determine which of the plurality of business object entities are available to the design-time tool;
providing a user interface with indications of which of the plurality of business object entities are available to the design-time tool.

9. The non-transitory computer readable storage medium of claim 8 wherein method further comprises performing, using the consumption service, a check routine to determine which of the plurality of business object entities are available to the design-time tool.

10. The non-transitory computer readable storage medium of claim 9 wherein the check routine comprises a plurality of checks and check logic.

11. The non-transitory computer readable storage medium of claim 10 wherein the checks and check logic are based on a plurality of factors comprising an SADL mode and consumption scenario.

12. The non-transitory computer readable storage medium of claim 9 wherein the method further comprises providing a user interface comprising a plurality of indications of availability status for the plurality of business object entities.

13. The non-transitory computer readable storage medium of claim 12 wherein the indications of availability status comprise error codes or error messages.

14. A computer system comprising:
one or more processors;
a software program, executable on said computer system, the software program configured to:
provide a design-time tool that operates on a business object comprising a plurality of business object entities;
reference a consumption service to determine which of the plurality of business object entities are available to the design-time tool;
provide a user interface with indications of which of the plurality of business object entities are available to the design-time tool.

15. The computer system of claim 14 wherein the software program is further configured to perform, using the consumption service, a check routine to determine which of the plurality of business object entities are available to the design-time tool.

16. The computer system of claim 15 wherein the check routine comprises a plurality of checks and check logic.

17. The computer system of claim 16 wherein the checks and check logic are based on a plurality of factors comprising an SADL mode and consumption scenario.

18. The computer system of claim 15 wherein the software program is further configured to provide a user interface comprising a plurality of indications of availability status for the plurality of business object entities.

19. The computer system of claim 18 wherein the indications of availability status comprise error codes or error messages.

20. The computer system of claim 19 wherein the design-tool and performing the check routine are separate from a compiler.
